(19) United States
(12) Patent Application Publication
(10) Pub. No.: US 2007/0197757 A1
(43) Pub. Date: Aug. 23, 2007

(54) Continuous production of aminofunctional siloxanes

(75) Inventors: Oliver Schaefer, Burghausen (DE); Sabine Delica, Munchen (DE)

Correspondence Address: BROOKS KUSHMAN P.C., 1000 TOWN CENTER, TWENTY-SECOND FLOOR, SOUTHFIELD, MI, 48075, US

(73) Assignee: Consortium fuer elecktrochemische Industrie GmbH, Munich (DE)

(21) Appl. No.: 10/598,652

(22) PCT Filed: Feb. 24, 2005
(86) PCT No.: PCT/EP05/01968

§ 371 Date: Sep. 7, 2006

(30) Foreign Application Priority Data
Mar. 11, 2004 (DE) 102004011992.9

(51) Int. Cl. C08G 77/26

(52) U.S. Cl. 528/38; 528/37

(57) ABSTRACT

Aminoalkyl-functional siloxanes are prepared efficiently by a continuous process in which a cyclic silazane and a hydroxyl-functional siloxane are fed continuously to a reaction zone, reacted in the reaction zone, and the aminoalkyl product and any unreacted starting materials are removed from the reaction zone. The process is effective even with hydroxyl-functional siloxanes having a very low weight percentage of hydroxyl groups.

The invention relates to a continuous method for the production of amino-functional siloxanes using cyclic silazanes.

Aminoalkylpolysiloxanes and aminoalkylsilicone resins can be used in many applications, including the production of polyimides and polyetherimides. However, the commercial use of these compounds on a larger scale is prevented by a relatively expensive production process.

U.S. Pat. No. 3,146,250 and DE 10051886 A disclose a method which starts from special cyclic silazanes of the general formula I which can react with HO—Si groups of a silicone component.

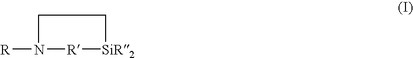

Here, R′ is a carbon chain having at least 3 and not more than 6 carbon atoms, R″ is a hydrocarbon radical and the radical R on the nitrogen is either hydrogen, a hydrocarbon radical or an organosilyl radical of the general formula (amine-R¹—)Y2Si—, where Y and R¹ are hydrocarbon radicals. If the radical R is hydrogen, an unsubstituted cyclic silazane which can be used for functionalizing hydroxyl-terminated silanols is obtained. The advantage of the reaction of these cyclic silazanes is that, owing to their ring tension, they undergo quantitative reaction very rapidly with Si—OH groups at elevated temperatures. The reaction times in some cases are in the one-digit minute range.

However, a disadvantage of the batchwise production known to date of, for example, linear alpha, omega-substituted silicone oils is that they have to be heated to temperatures of about 60-140° C. to achieve short reaction times. This is the case in particular with the silicone oils which carry only a small proportion of amino groups, since here the reaction takes place extremely slowly owing to the low reactivity of the reactants at room temperature. However, this has the technical disadvantage that the actual reaction times at elevated temperatures are very short but the time for heating up the reaction mixture or for cooling the product mixture is very long, particularly on the industrial scale, and can thus cancel out the advantages of the reactivity of the cyclic silazanes. A method which permits the conversion of cyclic silazanes having Si—OH functional groups very rapidly into amino-functional siloxanes was therefore sought.

The invention relates to a continuous method for the production of amino-functional organosiloxane of the general formula III
(SiO_{4/2})ₖ(R¹SiO_{3/2})ₘ(R¹₂SiO_{2/2})ₚ(R¹₃SiO_{1/2})_{q}[O_{1/2}SiR¹₂—R—NH₂]ₛ[O_{1/2}H]ₜ (III),
in which organosiloxane general formula IV
(SiO_{4/2})ₖ(R¹SiO_{3/2})ₘ(R¹₂SiO_{2/2})ₚ(R¹₃SiO_{1/2})_{q}[O_{1/2}H]ᵣ (IV),
is reacted with cyclic silazane of the general formula V 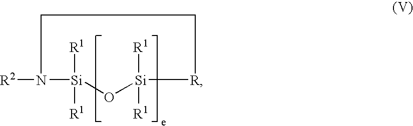
in which
R is a divalent Si—C— and Si—N-bonded, optionally cyano- or halogen-substituted C₃-C₁₅-hydrocarbon radical in which one or more non-neighboring methylene units may be replaced by —O—, —CO—, —COO—, —OCO— or —OCOO—, —S— or —NR^{x}- groups and in which one or more non-neighboring methine units can be replaced by —N═, —N═N— or —P═ groups, at least 3 and not more than 6 atoms being arranged between silicon atom and nitrogen atom of the ring,
R^{x} is hydrogen or a C₁-C₁₀-hydrocarbon radical optionally substituted by —CN or halogen,
R¹ is a hydrogen atom or a monovalent Si—C-bonded C₁-C₂₀-hydrocarbon radical or C₁-C₁₅-hydrocarbonoxy radical that is optionally substituted by —CN, —NCO, —NR^{x}₂, —COOH, —COOR^{x}, -halogen, -acryloyl, -epoxy, —SH, —OH or —CONR^{x}₂ and in which in each case one or more non-neighboring methylene units may be replaced by —O—, —CO—, —COO—, —OCO— or —OCOO—, —S— or —NR^{x}- groups and in which one or more non-neighboring methine units may be replaced by —N═, —N═N— or —P═ groups,
R² may be hydrogen or a C₁-C₁₀-hydrocarbon radical optionally substituted by a —CN or halogen or may be a radical of the general formula VIII 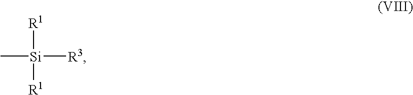
   in which
R³ is hydrogen or a C₁-C₁₀-hydrocarbon radical optionally substituted by —CN, —NR^{x} or halogen,
e has values of greater than or equal to 0,
s has values of at least 1,
r has values of at least 1,
s+t have the value of r and
k+m+p+q have values of at least 2,
   the silazane of the general formula V and the organosiloxane of the general formula IV being fed continuously to a reactor, being mixed there and reacted with one another and then being removed from the reactor region.

By means of this procedure, it is possible to heat the required components to the desired reaction temperatures in a very short time, mixing taking place at the same time. The products emerging from the reactor can subsequently be rapidly and effectively cooled owing to the small volume. The required reactor volume can be kept very small owing to the short residence times, it simultaneously being possible for the producible amounts to be very large. At the same time, undesired impurities of a reactant can be removed in a targeted manner in the reactor space by the action of elevated temperatures possibly in combination with a vacuum. This can be effected either after the addition or before the addition of the second reactant.

A further advantage is that, owing to the high surface area/volume ratio in the continuously operated reactor, the product can be simultaneously blanketed or saturated, for example with nitrogen, with the result that the oxygen present in the starting materials is displaced. The amine formed is thus less susceptible to yellowing.

The cyclic silazane of the general formula V which are used can be prepared easily and in high yields. They also react with hydroxy-functional siloxanes of the general formula IV without formation of byproducts and without the use of special catalysts.

In the cyclic silazanes of the general formula V, R may be aliphatically saturated or unsaturated, aromatic, straight-chain or branched. R is preferably a straight-chain C₃-C₆-alkylene radical which may be substituted by halogen atoms, particularly fluorine and chlorine. Preferably, 3 atoms are arranged between silicon atom and nitrogen atom of the ring.

The C₁-C₂₀-hydrocarbon radicals and C₁-C₂₀-hydrocarbonoxy radicals R¹ may be aliphatically saturated or unsaturated, aromatic, straight-chain or branched. R¹ preferably has 1 to 12 atoms, in particular 1 to 6 atoms, preferably only carbon atoms, or an alkoxy oxygen atom and otherwise only carbon atoms. Preferably, R¹ is a straight-chain or branched C₁-C₆-alkyl radical. The radicals methyl, ethyl, phenyl, vinyl and trifluoropropyl are particularly preferred. The radical R² is preferably hydrogen or a C₁-C₃-hydrocarbon radical or a radical of the general formula VIII. An aminoalkyl radical is preferred as radical R³. Hydrogen, methyl or a radical of the general formula VIII is very particularly preferred as radical R². E is preferably 0 or 1, very particularly preferably 0.

The compounds of the general formula III in which R is a propylene radical and R¹ is methyl, ethyl, phenyl, vinyl or trifluoropropyl are preferably prepared.

The amino-functional organosiloxane of the general formula III may be linear, cyclic or branched. The sum of k, m, p, q, s and t is preferably a number from 2 to 20 000, in particular from 8 to 1000. In order to permit a reaction between the organosiloxane of the general formula IV and the silazane, r must be >0, i.e. the organosiloxane of the general formula IV must contain hydroxyl groups.

A preferred variant of the branched organosiloxane of the general formula III is an organosilicone resin. This may consist of a plurality of units, as indicated in the general formula III, the mole percentages of the units present being designated by the indices k, m, p, q, r, s and t. A value of from 0.1 to 20% of units r, based on the sum of k, m, p, q and r, is preferred. At the same time, however, k+m must also be >0. In the organosiloxane resin of the general formula III, s must be >0 and s+t must be equal to r.

Preferred resins here are those in which 5% <k+m <90%, based on the sum of k, m, p, q, r, s and t, and t is preferably equal to 0. In a particularly preferred case, the radical R is a propyl radical and R¹ is a methyl radical.

If it is intended here to prepare resins which have only a defined amine content, the stoichiometric ratios between resin and cyclic silazane are chosen so that the desired amine content is achieved. The remaining Si—OH group can optionally remain in the product.

A further preferred variant of an amino-functional organosiloxane of the general formula III is a linear organosiloxane of the general formula VI
[H]ᵤ[H₂N—R—SiR¹₂]ᵥO(SiR¹₂O)ₙSiR¹₂—R—NH₂ (VI)
which is prepared from an organosiloxane of the general formula VII below
HO(R¹₂SiO)ₙR¹₂SiOH (VII)
with a cyclic silazane of the above general formula V,
u having the values 0 or 1,
v having the values 1-u and
n being a number from 1 to 20 000.
u preferably has the value 0.
n preferably has values of from 1 to 20 000, in particular from 8 to 2000.

If a mixture of starting compounds of the general formula VII is used the value of n is the average of the degrees for polymerization of the existing silanols of the general formula VII.

The linear organosiloxanes of the general formula VI which are prepared in this manner can be characterized substantially by 3 different parameters:
viscosity (or molecular weight)
amine content
degree of amino-functionality of the terminal groups

However, in the case of a linear organosiloxane of the general formula VI, only two of these parameters can be varied independently of one another, i.e. the amine content is fixed with fixed viscosity and functionality. The functionality is fixed in the case of fixed amine content and viscosity, and the viscosity is fixed in the case of fixed amine content and functionality.

If it is intended to prepare only a linear organosiloxane of the general formula VI, in which the degree of functionalization plays no role, i.e. in the case of the silicone oils, these need not have functionality of 2 but are described only by the total amine content and their viscosity, a suitable organosiloxane of the general formula VII which imparts the desired viscosity to the end product is used as the silicone component and a cyclic silazane of the general formula V is used for the functionalization, in particular in the amount which is to correspond to the amine content of the final product.

The compounds of the general formula VI furthermore have the advantage that, if u is >0, they can be condensed either with themselves or with compounds of the general formula VII, optionally with promotion by a catalyst, in order likewise to prepare compounds of the general formula VI which, however, have a higher molecular weight, i.e. the numerical value of the number n increases. In a particularly preferred case n is a number from 15 to 50 before the condensation and from 50 to 2000 after the condensation.

In the process for the preparation of an amino-functional organosiloxane of the general formula III, the amount of the silazanes of the general formula V which are used is dependent on the amount of the silanol groups to be functionalized. However, if it is intended to achieve complete functionalization of the OH groups, the silazane should be added in at least equimolar amounts. If the cyclic silazane is used in excess, the unreacted silazane can subsequently be either distilled off or hydrolyzed and then optionally removed.

The process is preferably carried out at from 0° C. to 100° C., particularly preferably at at least 10° C. to at least 40° C. The procedure is optionally effected in vacuo or under superatmospheric pressure or at atmospheric pressure (0.1 Mpa).

In a preferred embodiment, the procedure is effected with the use of an inert gas, such as, for example, nitrogen or argon.

Preferred reactors are continuous kneaders, extruders, single-screw, twin-screw or multiscrew extruders, designed so as to be either co-rotating or counterrotating, and glass reactors or static or dynamic mixers. Twin-screw kneaders (or twin-screw extruders) and static mixers are very particularly preferred.

The process can be carried out either with the use of solvents or without the use of solvents. With the use of solvents, inert, in particular aprotic solvents, such as aliphatic hydrocarbons, e.g. heptane or decane, and aromatic hydrocarbons, e.g. toluene or xylene, are preferred. It is also possible to use ethers, such as THF, diethyl ether or MTBE.

The amount of the solvent should be sufficient to ensure sufficient homogenization of the reaction mixture. Solvents or solvent mixtures having a boiling point or boiling range of up to 120° C. at 0.1 MPa are preferred.

If the silazane of the general formula VI is added to the organosiloxane of the general formula IV in less than a stoichiometric amount, unreacted Si—OH groups can remain in the amino-functional organosiloxane of the general formula III or can be reacted with other silazanes of the following general formula VIII:

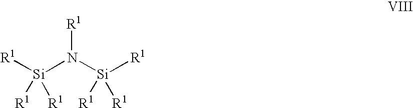

An amino-functional organosiloxane of the general formula IX
(SiO_{4/2})ₖ(R¹SiO_{3/2})ₘ(R¹₂SiO_{2/2})ₚ(R¹₃SiO_{1/2})_{q}[O_{1/2}SiR¹₂—R—NH₂]ₛ[O_{1/2}H]ₜ(O_{1/2}SiR¹₃)_{w} (IX)
R, R¹, k, m, p, q and s are as defined above. t is greater than or equal to 0, w is greater than 0 and s+t+w=r, r being defined in the above general formula V.

Silazanes of the general formula VIII can be used simultaneously with a cyclic silazane of the general formula V or after the reaction of the silazane of the general formula V.

Amino-functional organosiloxanes of the general formula IX which have been prepared by using silazanes of the general formula VIII and with cyclic silazanes of the general formula V can be used, for example, for increasing the amine number in highly viscous amino silicones. It is ensured thereby that, with these mixtures of aminosilicones and aminosilicone resins, mixtures which combine a high amine number with a high viscosity are obtained. This is a combination which cannot be achieved in this manner with difunctional aminosilicones.

If linear organosiloxanes of the above general formula VII are reacted with both silazanes of the general formula V and silazanes of the general formula VIII, compounds of the general formula X
[R¹₃Si]ᵤ[H₂N—R—SiR¹₂]ᵥO(SiR¹₂O)ₙSiR¹₂—R—NH₂ X
in which R¹, R and n are as defined above and on average u >0, v <1 and u+v=1, are obtained.

However, this double termination can optionally also be omitted but has substantial advantages with regard to the stability of the materials at elevated temperatures, since Si—OH groups tend to undergo condensation at higher temperatures and thus increase the viscosity of the solutions obtained.

A silazane of the general formula V can be prepared by a process in which a haloalkyldialkylchlorosilane according to general formula XI 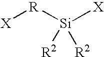
or bishaloalkyltetraalkyldisilazane of the general formula XII 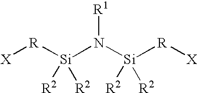
or a mixture of compounds of the general formulae XI and XII, in which
X is F, Cl, Br, or I,
R² has the meanings of R¹ and
R¹ and R have the above meanings,
   is reacted with ammonia, preferably under pressure.

All above symbols of the above formulae have their meanings in each case independently of one another.

In the following examples, unless stated otherwise in each case, all quantity and percentage data are based on weight, all pressures are 0.10 MPa (abs.) and all temperatures are 20° C.

### EXAMPLE 1

In a twin-screw kneader from Collin, Ebersberg, Germany, having 6 heating zones, an Si—OH-terminated polydimethylsiloxane having an OH content of 1.21% and a viscosity of 50 mPa·s was metered at 14.0 g/min (corresponding to 169.4 mg OH/min or 9.96 mmol/min) under a nitrogen atmosphere in the first heating zone. In the second heating zone, N-((3-aminopropyl)dimethylsilyl)-2,2-dimethyl-1-aza-2-silacyclopentane (M=230 g/mol, 97% strength) was metered in at 1.15 g/min. The temperature profile of the heating zones was programmed as follows: zone 1 50° C., zone 2 100° C., zone 3 120° C., zone 4 120° C., zone 5 120° C., zone 6 120° C. The speed was 50 rpm. Colorless bisaminopropylpolydimethylsiloxane could be taken off continuously at the extruder die and was cooled and, according to Si—NMR, had an Si—OH content of <30 ppm.

### EXAMPLE 2

In a twin-screw kneader from Collin, Ebersberg, Germany, having 6 heating zones, an Si—OH-terminated polydimethylsiloxane having an OH content of 3.62% and a viscosity of 12 mPa·s was metered at 10.0 g/min (corresponding to 362 mg OH/min or 21.3 mmol/min) under a nitrogen atmosphere in the first heating zone. In the second heating zone, N-((3-aminopropyl)dimethylsilyl)-2,2-dimethyl-1-aza-2-silacyclopentane (M=230 g/mol, 97% strength) was metered in at 2.45 g/min. The temperature profile of the heating zones was programmed as follows: zone 1 50° C., zone 2 100° C., zone 3 120° C., zone 4 120° C., zone 5 120° C., zone 6 120° C. The speed was 50 rpm. Colorless bisaminopropylpolydimethylsiloxane could be taken off continuously at the extruder die and was cooled and, according to Si—NMR, had an Si—OH content of <50 ppm.

### EXAMPLE 3

In a twin-screw kneader from Collin, Ebersberg, Germany, having 6 heating zones, an Si—OH-terminated polydimethylsiloxane having an OH content of 0.34% and a viscosity of 450 mPa·s was metered at 10.0 g/min (corresponding to 34 mg OH/min or 2.0 mmol/min) under a nitrogen atmosphere in the first heating zone. In the second heating zone, N-((3-aminopropyl)dimethylsilyl)-2,2-dimethyl-1-aza-2-silacyclopentane (M=230 g/mol, 97% strength) was metered in at 0.238 g/min. The temperature profile of the heating zones was programmed as follows: zone 1 50° C., zone 2 100° C., zone 3 120° C., zone 4 120° C., zone 5 120° C., zone 6 120° C. The speed was 50 rpm. Colorless bisaminopropylpolydimethylsiloxane could be taken off continuously at the extruder die and was cooled and, according to Si—NMR, had an Si—OH content of <28 ppm.

1-11. (canceled)

12. A continuous process for the production of amino-functional organosiloxane of the formula III
(SiO_{4/2})ₖ(R¹SiO_{3/2})ₘ(R¹₂SiO_{2/2})ₚ(R¹₃SiO_{1/2})_{q}[O_{1/2}SiR¹₂—R—NH₂]ₛ[O_{1/2}H]ₜ (III),
comprising:
continuously feeding to a reaction zone, an organosiloxane of formula IV
(SiO_{4/2})ₖ(R¹SiO_{3/2})ₘ(R¹₂SiO_{2/2})ₚ(R¹₃SiO_{1/2})_{q}[O_{1/2}H]ᵣ (IV),
and continuously feeding to said reaction zone a cyclic silazane of the formula V 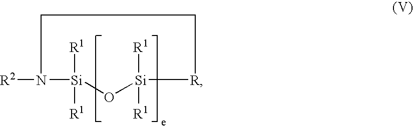
and reacting said organosiloxane of formula IV and cyclic silazane of formula V in said reaction zone,
R is a divalent Si—C— and Si—N-bonded, optionally cyano- or halogen-substituted C₃₋₁₅ hydrocarbon radical in which one or more non-neighboring methylene units may be replaced by —O—, —CO—, —COO—, —OCO— or —OCOO—, —S— or —NR^{x}- groups and in which one or more non-neighboring methine units can be replaced by —N═, —N═N— or —P═ groups, at least 3 and not more than 6 atoms being arranged between the N-bonded silicon atom and the nitrogen atom of the ring;
R^{x} is hydrogen or a C₁₋₁₀ hydrocarbon radical optionally substituted by —CN or halogen;
R¹ is a hydrogen atom or a monovalent Si—C-bonded C₁₋₂₀ hydrocarbon radical or C₁₋₁₅ hydrocarbonoxy radical optionally substituted by —CN, —NCO, —NR^{x}₂, —COOH, —COOR^{x}, -halogen, -acryloyl, -epoxy, —SH, —OH or —CONR^{x}₂, wherein one or more non-neighboring methylene units may be replaced by —O—, —CO—, —COO—, —OCO— or —OCOO—, —S— or —NR^{x}- groups, and wherein one or more non-neighboring methine units may be replaced by —N═, —N═N— or —P═ groups,
R² may be hydrogen or a C₁₋₁₀ hydrocarbon radical optionally substituted by a —CN or halogen or may be a radical of the formula VIII 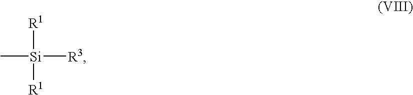
in which
R³ is hydrogen or a C₁-C₁₀-hydrocarbon radical optionally substituted by —CN, —NR^{x} or halogen,
e is a whole number greater than or equal to 0,
s is a whole number of at least 1,
r is a whole number of at least 1,
s+t have the value of r and
k+m+p+q have values of at least 2,
and then continuously removing amino-functional organosiloxane of formula III and any unreacted organosiloxane IV and silazane V from the reaction zone.

13. The process of claim 12, wherein the reactor is selected from the group consisting of continuous kneaders, extruders, glass reactors, static mixers, and dynamic mixers.

14. The process of claim 12, in which R is a straight-chain C₃₋₆ alkylene radical optionally substituted by halogen atoms.

15. The process of claim 12, wherein R¹ is methyl, ethyl, phenyl, vinyl or trifluoropropyl.

16. The process of claim 12, wherein the sum of k, m, p, q, s and t is a number from 2 to 20,000.

17. The process of claim 12, wherein resins are prepared in which 5% <k+m <90%, based on the sum of k, m, p, q, r, s and t.

18. The process of claim 12, wherein a linear organosiloxane of the formula VI
[H]ᵤ[H₂N—R—SiR¹₂]ᵥO(SiR¹₂O)ₙSiR¹₂—R—NH₂ (VI)
is prepared by reacting an organosiloxane of the formula VII
HO(R¹₂SiO)ₙR¹₂SiOH (VII)
with a cyclic silazane of the formula V,
u having the values 0or 1,
v having the values 1-u and
n being a number from 1 to 20,000.

19. The process of claim 12, wherein the reaction zone is maintained at a temperature of from 0° C. to 100° C.

20. The process of claim 12, in which an amino-functional organosiloxane of the formula IX
(SiO_{4/2})ₖ(R¹SiO_{3/2})ₘ(R¹₂SiO_{2/2})ₚ(R^{l}₃SiO_{1/2})_{q}[O_{1/2}SiR¹₂—R—NH₂]ₛ[O_{1/2}H]ₜ(O_{1/2}SiR¹₃)_{w} (IX)
is prepared by adding a silazane of the formula VI to an organosiloxane of the formula IV in less than a stoichiometric amount, and reacting unconverted Si—OH groups in the amino-functional organosiloxane of the formula III with a silazane of the formula VIII 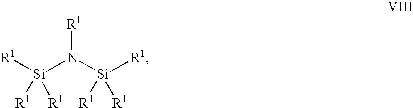
in which
t is greater than or equal to 0,
w is greater than 0 and
s+t+w=r.

21. The process of claim 20, in which silazanes of the formula VIII are employed after reaction with a silazane of the formula V.

22. The process of claim 12, in which N-((3-aminopropyl)dimethylsilyl)-2,2-dimethyl-1-aza-2-silacyclopentane is used as at least one silazane of the formula (V).
